(19) United States
(12) Patent Application Publication
(10) Pub. No.: US 2025/0351124 A1
(43) Pub. Date: Nov. 13, 2025

(54) VALIDATING PHYSICAL UPLINK SHARED CHANNEL (PUSCH) RESOURCE OCCASIONS

(71) Applicant: QUALCOMM Incorporated, San Diego, CA (US)

(72) Inventors: Ahmed Attia ABOTABL, San Diego, CA (US); Nazmul ISLAM, Littleton, MA (US); Hung Dinh LY, San Diego, CA (US); Muhammad Sayed Khairy ABDELGHAFFAR, San Jose, CA (US)

(21) Appl. No.: 18/658,595

(22) Filed: May 8, 2024

(51) Int. Cl. H04W 72/0446; H04L 5/00; H04W 72/23; H04W 74/0833

(52) U.S. Cl. CPC H04W 72/0446; H04L 5/0051; H04L 5/0053; H04W 72/23; H04W 74/0833

(57) ABSTRACT

Methods, systems, and devices for wireless communications are described. In some examples, a user equipment (UE) may receive first control signaling that indicates a set of physical uplink shared channel (PUSCH) occasions, a set of random access channel (RACH) occasions, a set of synchronization signal block (SSB) resources, or a combination thereof. Additionally, the UE may receive second control signaling indicating an update to the set of RACH occasions, an update to the set of SSB resources, or both. Accordingly, the UE may perform a validation procedure to determine whether to invalidate or validate at least a first PUSCH occasion of the set of PUSCH occasions based on the update to the set of RACH occasions, the update to the set of SSB resources, or both. Based on performing the validation procedure, the UE may communicate via the set of PUSCH occasions according to the results of the validation procedure.

### FIELD OF TECHNOLOGY

The following relates to wireless communications, including validating physical uplink shared channel (PUSCH) resource occasions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling that indicates a set of physical uplink shared channel (PUSCH) occasions, a set of random access channel (RACH) occasions, a set of synchronization signal block (SSB) resources, or a combination thereof, receiving second control signaling that indicates an update to the set of RACH occasions, an update to the set of SSB resources, or both, performing a validation procedure to determine whether to invalidate or validate at least a first PUSCH occasion of the set of PUSCH occasions based on the update to the set of RACH occasions, the update to the set of SSB resources, or both, and communicating via the set of PUSCH occasions according to the validation procedure.

A UE for wireless communications is described. The UE may include one or more memories storing processor executable code, and one or more processors coupled with the one or more memories. The one or more processors may individually or collectively be operable to execute the code to cause the UE to receive first control signaling that indicates a set of PUSCH occasions, a set of RACH occasions, a set of SSB resources, or a combination thereof, receive second control signaling that indicates an update to the set of RACH occasions, an update to the set of SSB resources, or both, perform a validation procedure to determine whether to invalidate or validate at least a first PUSCH occasion of the set of PUSCH occasions based on the update to the set of RACH occasions, the update to the set of SSB resources, or both, and communicate via the set of PUSCH occasions according to the validation procedure.

Another UE for wireless communications is described. The UE may include means for receiving first control signaling that indicates a set of PUSCH occasions, a set of RACH occasions, a set of SSB resources, or a combination thereof, means for receiving second control signaling that indicates an update to the set of RACH occasions, an update to the set of SSB resources, or both, means for performing a validation procedure to determine whether to invalidate or validate at least a first PUSCH occasion of the set of PUSCH occasions based on the update to the set of RACH occasions, the update to the set of SSB resources, or both, and means for communicating via the set of PUSCH occasions according to the validation procedure.

A non-transitory computer-readable medium storing code for wireless communications is described. The code may include instructions executable by one or more processors to receive first control signaling that indicates a set of PUSCH occasions, a set of RACH occasions, a set of SSB resources, or a combination thereof, receive second control signaling that indicates an update to the set of RACH occasions, an update to the set of SSB resources, or both, perform a validation procedure to determine whether to invalidate or validate at least a first PUSCH occasion of the set of PUSCH occasions based on the update to the set of RACH occasions, the update to the set of SSB resources, or both, and communicate via the set of PUSCH occasions according to the validation procedure.

In some examples of the method, UEs, and non-transitory computer-readable medium described herein, performing the validation procedure may include operations, features, means, or instructions for dropping the first RACH occasion from the set of RACH occasions and validating the first PUSCH occasion based on dropping the first RACH occasion.

In some examples of the method, UEs, and non-transitory computer-readable medium described herein, performing the validation procedure may include operations, features, means, or instructions for invalidating the first PUSCH occasion based on adding the first RACH occasion.

Some examples of the method, UEs, and non-transitory computer-readable medium described herein may further include operations, features, means, or instructions for maintaining a mapping between the set of PUSCH occasions and the set of RACH occasions based on adding the first RACH occasion and invalidating the first PUSCH occasion.

Some examples of the method, UEs, and non-transitory computer-readable medium described herein may further include operations, features, means, or instructions for adapting a mapping between a second set of PUSCH occasions and the set of RACH occasions based on adding the first RACH occasion and invalidating the first PUSCH occasion.

In some examples of the method, UEs, and non-transitory computer-readable medium described herein, performing the validation procedure may include operations, features, means, or instructions for invalidating the first PUSCH occasion based on removing the first RACH occasion from the set of RACH occasions.

In some examples of the method, UEs, and non-transitory computer-readable medium described herein, the update to the set of RACH occasions includes removing and the method, apparatuses, and non-transitory computer-readable medium may include further operations, features, means, or instructions for validating the first PUSCH occasion based on removing the first RACH occasion from the set of RACH occasions.

Some examples of the method, UEs, and non-transitory computer-readable medium described herein may further include operations, features, means, or instructions for maintaining a mapping between the set of PUSCH occasions and the set of RACH occasions based on invalidating the first PUSCH occasion.

Some examples of the method, UEs, and non-transitory computer-readable medium described herein may further include operations, features, means, or instructions for adapting a mapping between the set of PUSCH occasions and the set of RACH occasions based on removing the first RACH occasion and validating the first PUSCH occasion, where adapting the mapping includes removal of one or more PUSCH occasions from the set of PUSCH occasions.

In some examples of the method, UEs, and non-transitory computer-readable medium described herein, the update to the set of SSB resources includes adding a first SSB resource and the first SSB resource overlaps in time with the first PUSCH occasion; the first PUSCH occasion may be within a threshold quantity of symbols from the first SSB resource; or the first SSB resource succeeds, in time, the first PUSCH occasion.

In some examples of the method, UEs, and non-transitory computer-readable medium described herein, performing the validation procedure may include operations, features, means, or instructions for invalidating the first PUSCH occasion based on adding the first SSB resource.

Some examples of the method, UEs, and non-transitory computer-readable medium described herein may further include operations, features, means, or instructions for maintaining a mapping between the set of PUSCH occasions and the set of RACH occasions based on invalidating the first PUSCH occasion.

Some examples of the method, UEs, and non-transitory computer-readable medium described herein may further include operations, features, means, or instructions for adapting a mapping between the set of PUSCH occasions and the set of RACH occasions based on adding the first SSB resource and invalidating the first PUSCH occasion.

In some examples of the method, UEs, and non-transitory computer-readable medium described herein, performing the validation procedure may include operations, features, means, or instructions for excluding the first SSB resource from the set of SSB resources and validating the first PUSCH occasion based on excluding the first SSB resource.

In some examples of the method, UEs, and non-transitory computer-readable medium described herein, the update to the set of SSB resources includes removing a first SSB resource from the set of SSB resources and the first SSB resource overlaps in time with the first PUSCH occasion; the first PUSCH occasion may be within a threshold quantity of symbols from the first SSB resource; or the first SSB resource succeeds, in time, the first PUSCH occasion.

In some examples of the method, UEs, and non-transitory computer-readable medium described herein, performing the validation procedure may include operations, features, means, or instructions for invalidating the PUSCH occasion based on removing the first SSB resource from the set of SSB resources.

In some examples of the method, UEs, and non-transitory computer-readable medium described herein, performing the validation procedure may include operations, features, means, or instructions for validating the first PUSCH occasion based on removing the first SSB resource from the set of SSB resources.

Some examples of the method, UEs, and non-transitory computer-readable medium described herein may further include operations, features, means, or instructions for maintaining a mapping between the set of PUSCH occasions and the set of RACH occasions based on removing the first SSB resource and validating the first PUSCH occasion.

Some examples of the method, UEs, and non-transitory computer-readable medium described herein may further include operations, features, means, or instructions for adapting a mapping between the set of PUSCH occasions and the set of RACH occasions based on removing the first SSB resource and validating the first PUSCH occasion.

In some examples of the method, UEs, and non-transitory computer-readable medium described herein, the second control signaling indicates a priority of the first PUSCH occasion, and performing the validation procedure may include operations, features, means, or instructions for validating the first PUSCH occasion based on the priority of the first PUSCH occasion being greater than or equal to a priority associated with the update to the set of RACH occasions, being greater than or equal to a priority of the update to the set of SSB resources, or both and invalidating the first PUSCH occasion based on the priority of the first PUSCH occasion being less than the priority associated with the update to the set of RACH occasions, being less than the priority of the update to the set of SSB resources, or both.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports validating physical uplink shared channel (PUSCH) resource occasions in accordance with one or more aspects of the present disclosure.

FIG. 2 shows an example of a wireless communications system that supports validating PUSCH resource occasions in accordance with one or more aspects of the present disclosure.

FIG. 3A shows an example of a resource diagram that supports validating PUSCH resource occasions in accordance with one or more aspects of the present disclosure.

FIG. 3B shows an example of a resource diagram that supports validating PUSCH resource occasions in accordance with one or more aspects of the present disclosure.

FIG. 4 shows an example of a process flow that supports validating PUSCH resource occasions in accordance with one or more aspects of the present disclosure.

FIGS. 5 and 6 show block diagrams of devices that support validating PUSCH resource occasions in accordance with one or more aspects of the present disclosure.

FIG. 7 shows a block diagram of a communications manager that supports validating PUSCH resource occasions in accordance with one or more aspects of the present disclosure.

FIG. 8 shows a diagram of a system including a device that supports validating PUSCH resource occasions in accordance with one or more aspects of the present disclosure.

FIGS. 9 and 10 show flowcharts illustrating methods that support validating PUSCH resource occasions in accordance with one or more aspects of the present disclosure.

### DETAILED DESCRIPTION

In some wireless communications systems, a user equipment (UE) may perform a two-step random access procedure (e.g., two-step random access channel (RACH) procedure) to gain access to a network entity. For example, during the two-step random access procedure, the UE may transmit a first message (e.g., a message A (MSGA)), which may include a random access preamble message transmitted via a RACH occasion and include a physical uplink shared channel (PUSCH) message transmitted via a PUSCH occasion. In such examples, the UE may determine the PUSCH occasion from multiple PUSCH occasions based on the RACH occasion, the random access preamble, a synchronization signal block (SSB) received from the network entity, or a combination thereof. For example, according to a resource mapping between the RACH occasion and one or more PUSCH occasions, the UE may determine the PUSCH occasion to use to transmit the PUSCH as part of the first message.

In such examples, the UE may determine the PUSCH occasion according to one or more validation rules. For example, if a PUSCH occasion of the one or more PUSCH occasions overlaps in time with a RACH occasion, the PUSCH occasion may be deemed invalid. Additionally, if a PUSCH occasion of the one or more PUSCH occasions precedes a SSB resource in a slot, overlaps in time with the SSB resource, or succeeds the SSB resource within a threshold quantity of symbols, the PUSCH occasion may be deemed invalid. In this way, the UE may identify the PUSCH occasion to use for the first transmission according to the RACH occasion and the one or more validation rules. In some examples, to support network energy savings, the network entity may dynamically adapt (e.g., add or remove) a RACH occasion, a SSB resource, or both from a preconfigured (e.g., via system information block (SIB) signaling) set of RACH occasions and SSB resources. In such examples, however, if the adapted RACH occasion, SSB resource, or both, overlap with an already valid (or invalid) PUSCH occasion, the UE may be unable to identify a PUSCH occasion for the two-step RACH occasion, thereby increasing latency during the two-step RACH procedure. Thus, techniques to handle dynamically adapted RACH occasions and SSB resources may be desired.

In accordance with the techniques described herein, the UE may perform a validation procedure to determine whether a PUSCH occasion is valid or invalid in response to dynamic adaptation of the RACH occasions, the SSB resources, or both. For example, the UE may receive first control signaling (e.g., SIB) indicating a set of PUSCH occasions, a set of RACH occasions, and a set of SSB resources. Accordingly, the UE may receive second control signaling (e.g., paging indication) indicating an update to the set of RACH occasions, an update to the set of SSB resources, or both. In response to receiving the second control signaling, the UE may perform a validation procedure to determine whether a first PUSCH occasion of the set of PUSCH occasions is valid.

In one example, if a SSB resource or a RACH occasion is added, and such resources overlap in time with the first PUSCH occasion, the UE may exclude (e.g., drop) the SSB or RACH resource, and subsequently validate the first PUSCH occasion. Alternatively, the UE may determine to invalidate the first PUSCH occasion and proceed to add the SSB resource or RACH occasion to the respective sets. In another example, if a SSB resource or a RACH occasion are removed from the respective sets and such resources overlapped in time with the first PUSCH of the set, then the UE may determine to validate the first PUSCH occasion. Alternatively, the UE may maintain the invalid state of the first PUSCH occasion.

Aspects of the disclosure are initially described in the context of wireless communications systems. Aspects of the disclosure are further described in the context of resource diagrams and process flows. Aspects of the disclosure are further illustrated by and described with reference to apparatus diagrams, system diagrams, and flowcharts that relate to validating PUSCH resource occasions.

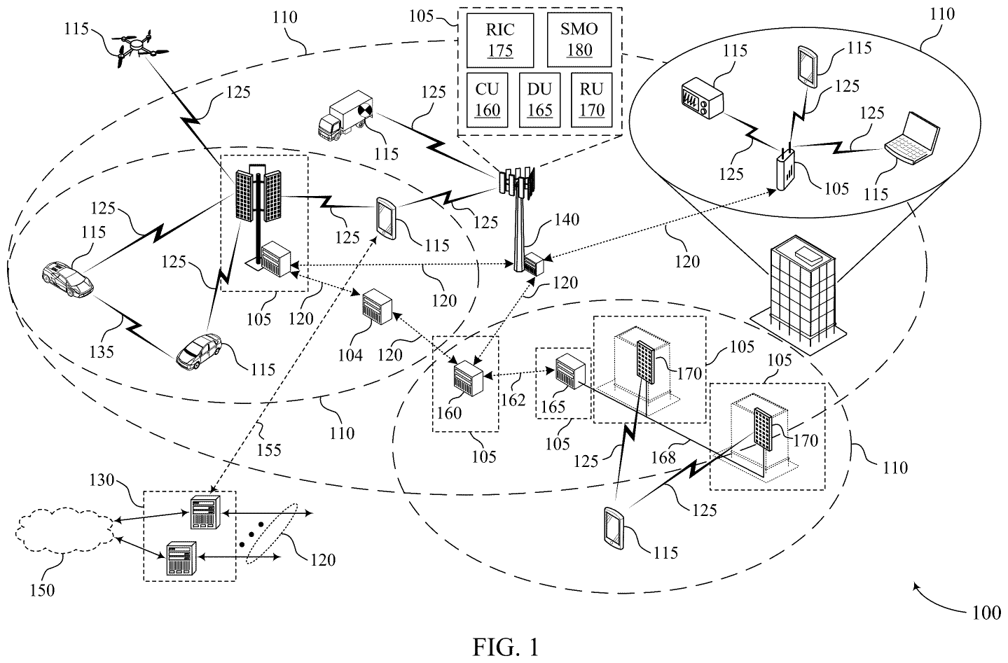

FIG. 1 shows an example of a wireless communications system 100 that supports validating PUSCH resource occasions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the UE 115 may perform a random access procedure (e.g., RACH procedure) to gain access to the network entity 105. In one example, the UE 115-a may perform a four step RACH procedure, where the UE 115-a may transmit a first message (e.g., message 1 (MSG1)) including a random access preamble. In response to receiving the first message, the network entity 105 may transmit a second message (e.g., message 2 (MSG2)) indicating a random access response (RAR). In response to receiving the second message, the UE 115 may transmit a third message (e.g., message 3 (MSG3) or a PUSCH), where the network entity 105 may respond to the third message by transmitting a fourth message (e.g., message 4 (MSG4)) including information associated with contention resolution.

In another example, the UE 115 may perform a two-step RACH procedure, where the UE 115 may transmit a first message (e.g., MSGA) that includes a transmission of both the random access preamble and the PUSCH via a PUSCH occasion. That is, the UE 115 may transmit a single message (e.g., MSGA) that combines the first message (e.g., MSG1) and the third message (e.g., MSG3) of the four-step RACH procedure. In response to receiving the first message (e.g., MSGA), the network entity 105 may transmit a second message (e.g., message B (MSGB)) indicating a RAR and information associated with contention resolution. That is, the network entity 105 may transmit a single message (e.g., MSGB) that combines the second message (e.g., MSG2) and the fourth message (e.g., MSG4) of the four-step RACH.

By performing the two-step RACH, the UE 115 may achieve reduced latency and signaling overhead during access to the network entity 105-b as compared to the four-step RACH. Additionally, the two-step RACH may enable the UE 115 to support timing advance (TA) free and grant-free uplink packet transmissions with varying transport block sizes (TBSs) and modulation and coding schemes (MCSs). In this way, by using the two-step RACH, the UE 115 and the network entity 105 may improve the capacity of the wireless communications system 100, improve power efficiency, or both as compared to the four step RACH procedure (e.g., four-step contention-based random access (CBRA)). Additionally, in some cases, the two-step RACH procedure may replace (e.g., be used instead of) handover procedures that do not utilize random access.

In some cases, however, the four-step RACH procedure may have one or more advantages over the two-step RACH procedure. For example, the UE 115 may experience performance degradation in the two-step RACH procedure as compared to the four-step RACH procedure due to the absence of TAs. Additionally, the two-step RACH procedure and the four-step RACH procedure may trade-off between collision probability (of the PUSCH portion of the MSGA) and resource overhead (e.g., due to the one to one mapping of PUSCH occasion and RACH occasion in the four-step RACH procedure and a one to many mapping in the two-step RACH procedure). Further, in some cases, the two-step RACH procedure may cause an increased quantity of wasted PUSCH occasions as compared to the four-step RACH procedure.

In some cases, during the two-step RACH procedure, the UE 115 may determine the PUSCH occasion from multiple PUSCH occasions based on the RACH occasion, the random access preamble, a SSB received from the network entity 105, or a combination thereof. For example, according to a resource mapping between the RACH occasion and one or more PUSCH occasions, the UE 115 may determine the PUSCH occasion to use to transmit the PUSCH as part of the first message.

In such examples, the UE 115 may determine the PUSCH occasion according to one or more validation rules. For example, if a PUSCH occasion of the one or more PUSCH occasion overlaps in time with a RACH occasion, the PUSCH occasion may be deemed invalid. Additionally, if a PUSCH occasion of the one or more PUSCH occasions precedes a SSB resource in a slot, overlaps in time with the SSB resource, or succeeds the SSB resource within a threshold quantity of symbols, the PUSCH occasion may be deemed invalid. In this way, the UE 115 may identify the PUSCH occasion to use for the first transmission according to the RACH occasion and the one or more validation rules. In some examples, to support network energy savings, the network entity 105-a may dynamically adapt (e.g., add or remove) a RACH occasion, a SSB resource, or both from a preconfigured (e.g., via SIB signaling) set of RACH occasions and SSB resources. In such examples, however, if the adapted RACH occasion, SSB resource, or both, overlap with an already valid (or invalid) PUSCH occasion, the UE 115 may be unable to identify a PUSCH occasion for the two-step RACH occasion, thereby increasing latency during the two-step RACH procedure. Thus, techniques to handle dynamically adapted RACH occasions and SSB resources may be desired.

In accordance with the techniques described herein, the UE 115 may perform a validation procedure to determine whether a PUSCH occasion is valid or invalid in response to dynamic adaptation of the RACH occasions, the SSB resources, or both. For example, the UE 115 may receive first control signaling indicating a set of PUSCH occasions, a set of RACH occasions, and a set of SSB resources. Accordingly, the UE 115 may receive second control signaling (e.g., paging indication) indicating an update to the set of RACH occasions, an update to the set of SSB resources, or both. In response to receiving the second control signaling, the UE 115 may perform a validation procedure to determine whether a first PUSCH occasion of the set of PUSCH occasions is valid.

In one example, if a SSB resource or a RACH occasion is added, and such resources overlap in time with the first PUSCH occasion, the UE 115 may exclude (e.g., drop) the SSB or RACH resource, and subsequently validate the first PUSCH occasion. Alternatively, the UE 115 may determine to invalidate the first PUSCH occasion and proceed to add the SSB resource or RACH occasion to the respective sets. In another example, if a SSB resource or a RACH occasion are removed from the respective sets and such resources overlapped in time with the first PUSCH of the set, then the UE 115 may determine to validate the first PUSCH occasion. Alternatively, the UE 115 may maintain the invalid state of the first PUSCH occasion.

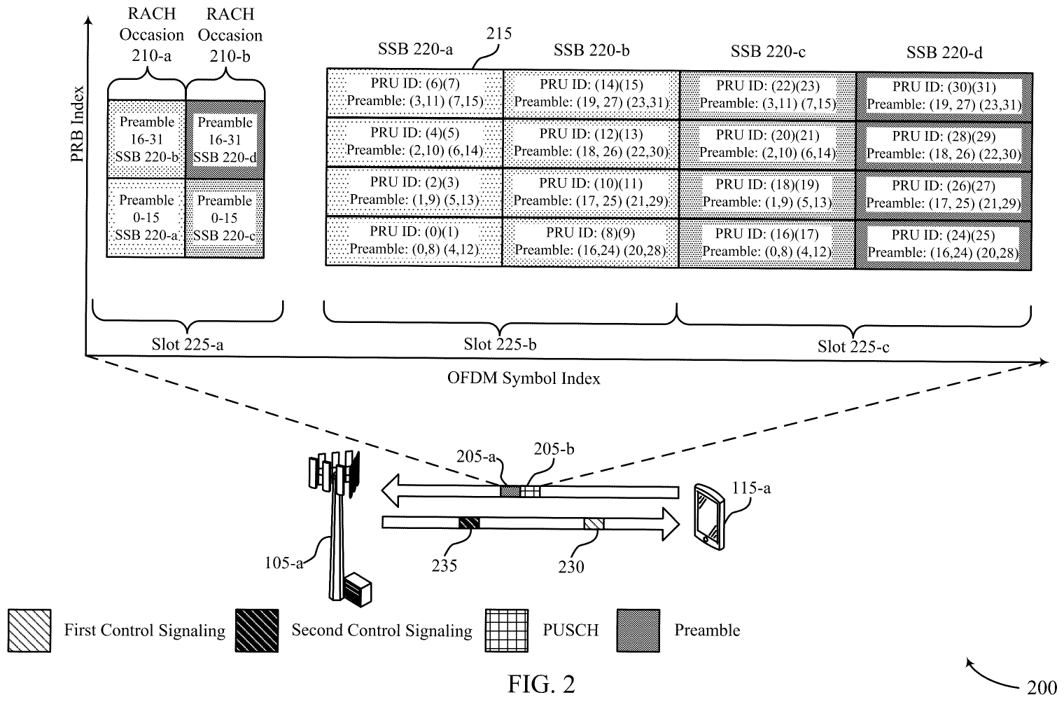

FIG. 2 shows an example of a wireless communications system 200 that supports validating PUSCH resource occasions in accordance with one or more aspects of the present disclosure. Aspects of the wireless communications system 200 may implement, or be implemented by, aspects of the wireless communications system 100 as described herein with reference to FIG. 1. For example, the wireless communications system 200 may include a UE 115-a and a network entity 105-a, which may be examples of the UE 115 and the network entity 105 as described herein. The techniques described in the context of the wireless communications system 200 may enable the UE 115-a to determine whether to validate, or invalidate, a PUSCH occasion 215 based on a dynamic adaptation (e.g., addition or removal) of a RACH occasion 210, a SSB 220, or both.

In some cases, to communicate with the network entity 105-a, the UE 115-a may perform a random access procedure, such as a two-step RACH procedure. For example, the UE 115-a may transmit a first message 205 (e.g., MSGA) that includes a preamble 205-a (e.g., random access preamble) and a PUSCH 205-b. In response to receiving the first message 205, the network entity 105-a may transmit a second message (e.g., MSGB, not shown) indicating a RAR to the preamble 205-a and information associated with contention resolution. In this way, the UE 115-a may access the network entity 105-a with reduced latency and reduced power consumption as compared to a four-step RACH procedure.

To transmit the first message 205, the UE 115-a may receive first control signaling (e.g., SIB, RRC signaling) allocating a set of RACH occasions 210 and allocating a set of PUSCH occasions 215. As described herein, a RACH occasion 210 may be the time (e.g., slot 225-a) and frequency (e.g., physical resource blocks (PRBs)) resources allocated for transmission of the preamble 205-a of the first message 205. During the two-step RACH procedure, multiple UEs 115 may share the same RACH occasions 210, where each UE 115 may select and transmit a respective preamble 205-a of a set of preambles 205-a (e.g., code domain multiplexing). For example, each RACH occasion 210 may include one or more PRBs, where each PRB of each RACH occasion 210 may be associated with a respective set of preambles 205-a (e.g., preambles with indices 0-15 or preambles with indices 16-31) and be associated with a respective SSB 220 (e.g., a respective index of the SSB 220, received by the UE, that carried the master information block (MIB) used to decode the first control signaling 230). Accordingly, the UE 115-a may select a preamble 205-a from a set of preambles 205-a and proceed to select a PRB of a RACH occasion 210 based on an index of the selected preamble 205-a, based on an index of the SSB 220, or both.

As an illustrative example, the UE 115-a may receive, via the first control signaling 230, an indication of a RACH occasion 210-a and a RACH occasion 210-b, where each RACH occasion spans two PRBs. In such examples, a first PRB of the RACH occasion 210-a may be associated with preambles 205-a having indices 0-15 and be associated with a SSB 220-a, while a second PRB of the RACH occasion 210-a may be associated with preambles 205-a having indices 16-31 and be associated with a SSB 220-b. Similarly, a first PRB of the RACH occasion 210-b may be associated with preambles 205-a having indices 0-15 and be associated with a SSB 220-c, while the second PRB of the RACH occasion 210-b may be associated with preambles 205-a having indices 16-31 and be associated with a SSB 220-d.

Accordingly, in response to receiving the first control signaling 230, the UE 115-a may select a preamble 205-a from the set of preambles 205-a (e.g., one of the preambles 0-31) and proceed to identify one of the PRBs of the RACH occasions 210 for transmission of the selected preamble 205-a. In one example, if the UE 115-a selects a preamble 205-a with an associated index between 0-15 and receives an SSB 220-a (e.g., that carries the MIB used to decode the first control signaling), the UE 115-a may select the first PRB of the RACH occasion 210-a for transmission of the selected preamble 205-a. In another example, if the UE 115-a selects a preamble 205-a with an associated index between 0-15 and receives an SSB 220-c, the UE 115-a may select the first PRB of the RACH occasion 210-b for transmission of the selected preamble 205-a. In this way, the UE 115-a may identify the PRB of the RACH occasion 210-a for transmission of the preamble 205-a.

As described herein, a PUSCH occasion 215 may be the time (e.g., a slot 225-b and a slot 225-c) and frequency resources (e.g., PRBs) allocated for the PUSCH 205-b. To support asynchronous uplink transmission (e.g., PUSCH 205-b) in the two-step RACH procedure, each PUSCH occasion 215 may have an associated guard time (e.g., time gap before and after the PUSCH 205-b) and guard band (e.g., frequency gap above and below the frequency used for the PUSCH 205-b) to mitigate inter-symbol interference and inter-channel interference. In some cases, the PUSCH occasions 215 may be referred to as a PUSCH resource unit (PRU) when the PUSCH occasion 215 is combined with a demodulation reference signal (DMRS) port and DMRS sequence for the PUSCH 205-b. In such examples, each PUSCH occasion 215 may be associated with one or more respective PRU identifiers (IDs).

In some cases, the contents and payload size of the first message 205 (e.g., MSGA) may depend on various use cases, depend on the quality of the link (e.g., channel) between the UE 115-a and network entity 105-a, depend on a mode of operation at the UE 115-a, or a combination thereof. For example, if the UE 115-a is operating in an RRC IDLE or RRC INACTIVE mode, the UE 115-a may include, within the payload of the first message 205, an identifier of the UE 115-a, one or more RRC requests, a relatively small quantity of data, or a combination thereof. Alternatively, if the UE 115-a is operating in an RRC CONNECTED mode, the UE 115-a may include, within the payload of the first message 205, information associated with medium access control-control elements (MAC CE), data associated with user plane functions, data associated with control plane functions, or a combination thereof. Additionally, the UE 115-a and the network entity 105-a may support multiple formats of the PUSCH occasions 215 to accommodate the different use cases, accommodate various coverage scenarios, or both. In some cases, because the first message 205 (e.g., MSGA) is not transmitted with a TA (e.g., has a bursty traffic pattern), a fixed or static periodic resource allocation for the PUSCH occasions 215 may be inefficient for a given payload size.

Accordingly, in response to selecting the RACH occasion 210 for the transmission of preamble 205-a, the UE 115-a may select, from the indicated set of PUSCH occasions 215, a valid PUSCH occasion 215 based on a mapping between the set of RACH occasions 210 and the set of PUSCH occasions 215. For example, each consecutive number of N_{preamble} preamble indexes from valid RACH occasions 210 (e.g., physical RACH (PRACH) occasions) in the slot 225-a (e.g., PRACH slot), first, in increasing order of preamble indexes within a single RACH occasion 210, second, in increasing order of frequency resource indexes for frequency multiplexed RACH occasions 210, and third, in increasing order of time resource indexes for time multiplexed PRACH occasions within the slot 225-a (e.g., PRACH slot), may be mapped to a valid PUSCH occasion 215 and associated DMRS resources, first in increasing order of frequency resource indexes f_{id} for frequency multiplexed PUSCH occasions 215, second, in increasing order of DMRS resource indexes within a PUSCH occasion 215, where a DMRS resource index DMRS_{id} is determined first in an ascending order of a DMRS port index and second in an ascending order of a DMRS sequence index, third, in increasing order of time resource indexes t_{id} for time multiplexed PUSCH occasions within the slots 225-b and 225-c (e.g., PUSCH slot), and fourth, in increasing order of indexes for Nₛ slots (e.g., PUSCH slots).

In such examples, N_{preamble} may be equal to the ceiling of T_{preamble} divided by T_{PUSCH}, where T_{preamble} may be the total quantity of valid RACH occasions 210 per association pattern period multiplied by the number of preambles per valid RACH occasion 210 provided by rach-ConfigCommonTwoStepRA (via the first control signaling 230 or other signaling from the network entity 105-a), and where T_{PUSCH} may be the total number of valid PUSCH occasions per PUSCH configuration per associated pattern period multiplied by the number of DMRS resource indexes per valid PUSCH occasions 215 provided by msgA-DMRS-Config (e.g., via the first control signaling 230 or other signaling from the network entity 105-a).

That is, each valid PUSCH occasion 215 may be mapped to (e.g., associated with) a respective PRB of a respective RACH occasion 210, be mapped to a respective preamble 205-a, be mapped to a respective SSB 220, or a combination thereof. Additionally, each RACH occasion 210 may have a defined set of PUSCH occasions 215, where the set of PUSCH occasions 215 are offset, in time and frequency, from the respective RACH occasion 210. As an illustrative example, if the UE 115-a selects a preamble 205-a with an index of 17 and received the SSB 220-b, the UE 115-a may select the second PRB of the RACH occasion 210-a to transmit the preamble 205-a. Accordingly, based on the mapping between the set of PUSCH occasions 215 and the RACH occasions 210, the UE 115-a may select a first PUSCH occasion 215 with a PRU ID of 10 and use the first PUSCH occasion 215 to transmit the PUSCH 205-b. In this way, the UE 115-a may utilize the aforementioned mapping between the set of RACH occasions 210 and the set of PUSCH occasions 215 to identify a PUSCH occasion 215.

As described herein, the UE 115-a may select a valid PUSCH occasion 215 of the set of PUSCH occasions 215 for transmission of the PUSCH 205-b. Accordingly, the UE 115-a may determine whether the PUSCH occasions are valid based on one or more rules. For example, a PUSCH occasion 215, of the set of PUSCH occasions 215, may be deemed valid if it does not overlap in time and frequency with any valid RACH occasion 210, where the RACH occasion 210 may be associated with either a first type random access procedure or a second type random access procedure. Additionally, for an unpaired spectrum and for SSBs 220 with indexes provided by ssb-PositionInBurst or by ServingCellConfigCommon, if the UE 115-a is not provided with tdd-UL-DL-ConfigurationCommon, a PUSCH occasion 215 may be valid if the PUSCH occasion 215 does not precede an SSB 220 in the slots 225-b and 225-c (e.g., PUSCH slots), and starts at least N_{gap} (e.g., a threshold quantity) of symbols after a last SSB 220 symbol, where N_{gap} is provided to the UE 115-a and, if channelAccessMode is equal to semiStatic is provided to the UE 115-a, does not overlap with consecutive symbols before the start of a next channel occupancy time where the UE 115-a does not transmit. Alternatively, if the UE 115-a is provided with tdd-UL-DL-ConfigurationCommon, a PUSCH occasion 215 is valid if the PUSCH occasion 215 is within an uplink symbol, does not precede an SSB 220 in the slots 225-b and 225-c (e.g., PUSCH slots), and starts at least N_{gap} (e.g., a threshold quantity) of symbols after a last SSB 220 symbol, where N_{gap} is provided to the UE 115-a and, if channelAccessMode is equal to semiStatic is provided to the UE 115-a, does not overlap with consecutive symbols before the start of a next channel occupancy time where the UE 115-a does not transmit.

That is, a PUSCH occasion 215 may be deemed valid if the PUSCH occasion 215 does not overlap, in time and frequency, with a RACH occasion 210. Additionally, a PUSCH occasion 215 may be deemed valid if the PUSCH occasion 215 does not precede a SSB 220 in a slot 225, does not overlap, time and frequency, with a SSB 220, does not start within a threshold quantity of symbols (e.g., N_{gap}) from an end symbol of the SSB 220. As such, according to the validation rules and the mapping between the RACH occasions 210 and the PUSCH occasions 215, the UE 115-a may determine a PUSCH occasion 215 and transmit the PUSCH 205-b via the determined PUSCH occasion 215.

In some cases, however, to support network energy savings, the network entity 105-a may dynamically adapt the set of RACH occasions 210 in the time domain or spatial domain (e.g., frequency domain), adapt a set of SSBs 220 in the time domain (e.g., adapt a periodicity of the SSBs 220), or both. Accordingly, because a validation of the PUSCH occasions 215 depend on the presence (e.g., location in time and frequency) of the SSBs 220 and the RACH occasions 210, the UE 115-a may be unable to handle such dynamically adapted resources. Thus, validation rules of the set of PUSCH occasions 215 under dynamic adaptation of RACH occasions 210, adaptation of SSBs 220, or both may be desired.

In accordance with the techniques described herein, the UE 115-a may perform a validation procedure to determine whether a PUSCH occasion 215 is valid or invalid in response to dynamic adaptation of the RACH occasions 210, the SSBs 220, or both. For example, the UE 115 may receive the first control signaling 230 (e.g., SIB) indicating the set of PUSCH occasions 215, indicating the set of RACH occasions 210, and indicating a set of resources associated with the SSBs 220. Accordingly, the UE 115-a may receive second control signaling 235 (e.g., paging indication or a paging message) indicating an update to the set of RACH occasions 210, an update to the set of resources associated with the SSBs 220, or both. That is, the UE 115-a may receive, via the second control signaling 235, an indication of a dynamic adaptation (e.g., addition of or removal from) the set of RACH occasions 210, the set of resources associated with the SSBs 220, or both. In response to receiving the second control signaling 235, the UE 115 may perform a validation procedure to determine whether a first PUSCH occasion 215 of the set of PUSCH occasions 215 is valid.

In some examples, if the network entity 105-a indicates, via the second control signaling 235, that a RACH occasion 210 is being added to the set of RACH occasions 210 and the RACH occasion 210 overlaps, in time and frequency, with an already valid PUSCH occasion 215, the UE 115-a may drop the additional RACH occasion 210 and maintain the validity of the PUSCH occasion 215. Alternatively, the UE 115-a may invalidate the already valid PUSCH occasion 215 and add in the RACH occasion 210. In such examples, if the UE 115-a adds in the indicated RACH occasion 210, the UE 115-a may maintain a previous mapping between the set of RACH occasions 210 and the set of PUSCH occasions 215. Alternatively, if the UE 115-a adds in the indicated RACH occasion 210, the UE 115-a may adapt the mapping between the set of RACH occasions and the set of PUSCH occasions 215.

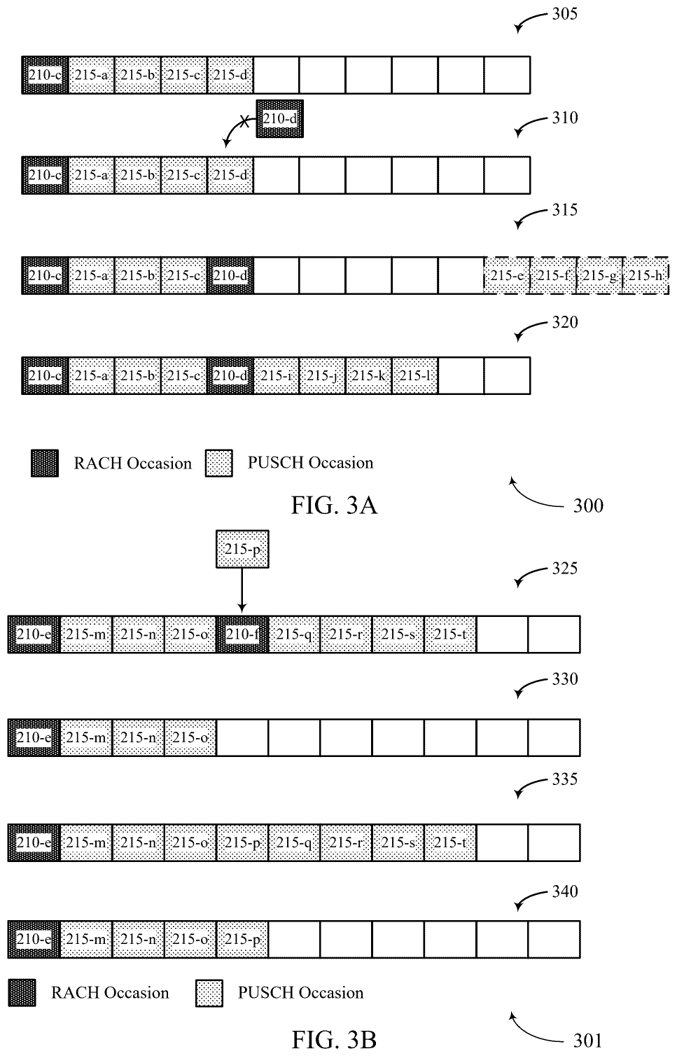

In some examples, if the network entity 105-a indicates, via the second control signaling 235, that a RACH occasion 210 is being removed from the set of RACH occasions 210 and the removed RACH occasion 210 overlaps, in time and frequency, with an already invalidated PUSCH occasion 215, the UE 115-a may remove the RACH occasion 210 and maintain the invalid state of the PUSCH occasion 215. Alternatively, the UE 115-a may remove the RACH occasion 210 from the set of RACH occasions and validate the previously invalidated PUSCH occasion 215. In such examples, in response to removing the RACH occasion 210 from the set of RACH occasions 210, the UE 115-a may maintain the mapping between the set of RACH occasions 210 and the set of PUSCH occasions 215. Alternatively, in response to removing the RACH occasion 210 from the set of RACH occasions 210, the UE 115-a may adapt the mapping between the set of RACH occasions 210 and the set of PUSCH occasions 215. Techniques for validating or invalidating PUSCH occasions 215 in response to an addition of a RACH occasion 210 may be further described herein with reference to FIG. 3A and techniques for validating or invalidating PUSCH occasions 215 in response to removal of a RACH occasion 210 may be further described herein with reference to FIG. 3B.

In some examples, if the network entity 105-a indicates, via the second control signaling 235, that a SSB 220 is being added to the set of SSBs 220 and the SSB 220 overlaps with, in time and frequency, an already valid PUSCH occasion 215, is within a threshold quantity of symbols from the start of the already valid PUSCH occasion 215, or succeeds, in time, the already valid PUSCH occasion, the UE 115-a may exclude the SSB 220 from the set of SSBs 220 and maintain the validity of the PUSCH occasion 215. Alternatively, the UE 115-a may add the SSB 220 and invalidate the PUSCH occasion 215. In some cases, if the UE 115-a adds the SSB 220, the UE 115-a may maintain the mapping between the RACH occasions 210 and the PUSCH occasions 215. Alternatively, if the UE 115-a adds the SSB 220, the UE 115-a may adapt the mapping between the RACH occasions 210 and the PUSCH occasions 215.

Similarly, if the network entity 105-a indicates, via the second control signaling 235, that a SSB 220 is being removed from the set of SSBs 220 and the removed SSB 220 overlaps with, in time and frequency, an invalid PUSCH occasion 215, is within a threshold quantity of symbols from the start of the invalid PUSCH occasion 215, or succeeds, in time, the invalid PUSCH occasion, the UE 115-a may remove the SSB 220 and maintain the invalidity of the PUSCH occasion. Alternatively, the UE 115-a may remove the SSB 220 and validate the previously invalidated PUSCH occasion 215. In some cases, if the UE 115-a removes the SSB 220, the UE 115-a may maintain the mapping between the RACH occasions 210 and the PUSCH occasions 215. Alternatively, if the UE 115-a removes the SSB 220, the UE 115-a may adapt the mapping between the RACH occasions 210 and the PUSCH occasions 215.

In some examples, as described herein, the UE 115-a may adapt the mapping between the RACH occasions 210 (e.g., the preambles 205-a) and the PUSCH occasions 215 in response to the adaptation (e.g., addition or removal) of a RACH occasion 210, a SSB 220, or both. In one example, if a RACH occasion 210 is removed, the UE 115-a may remove the PUSCH occasions 215 associated with the removed RACH occasion 210. In another example, if a RACH occasion 210 is added, the UE 115-a may also add in one or more PUSCH occasions 215 that are defined (e.g., offset), in time and frequency, from the added RACH occasion 210.

In another example, if a SSB 220 is removed, the UE 115-a may reorder, or adapt, the PRU IDs, preamble indices, SSB indices, or a combination thereof, of each PUSCH occasion 215 of the set of PUSCH occasions 215 or remove the PUSCH occasions 215 associated with the removed SSB 220. Alternatively, if a SSB 220 is added, the UE 115-a may reorder, or adapt, the PRU IDs, preamble indices, SSB indices, or a combination thereof, of each PUSCH occasion 215 of the set of PUSCH occasions 215, such that the PRU IDs, preamble indices, SSB indices, among other examples, may be adjusted for the additional SSB 220.

In some examples, the network entity 105-a may indicate, via the second control signaling 235, a priority of the set of PUSCH occasions, a priority of the already valid PUSCH occasion, a priority of the invalidated PUSCH occasion, or a combination thereof. Accordingly, the UE 115-a may determine whether to invalidate or validate a PUSCH occasion 215 based on the indicated priority. For example, if the network entity 105-a indicates an adaptation (e.g., addition) of an SSB 220 and indicates a relatively high priority for the set of PUSCH occasions 215, the UE 115-a may consider including the additional SSB 220 except in instances that will lead to an invalidation of one of the set of PUSCH occasions 215. Similarly, if the network entity 105-a indicates an adaptation (e.g., addition) of an RACH occasion 210 with a relatively high priority for the set of PUSCH occasions 215, the UE 115-a may consider to include the additional RACH occasion 210 except in instances that may lead to an invalidation of one of the set of PUSCH occasions 215.

As an illustrative example, if the UE 115-a receives, via the second control signaling 235, an indication to add a RACH occasion 210 and also receives an indication that a priority of the set of PUSCH occasions 215 is relatively high, the UE 115-a may refrain from adding the RACH occasion 210, if the RACH occasion 210 overlaps with an already valid PUSCH occasion 215. Alternatively, if the UE 115-a receives, via the second control signaling 235, an indication to add a RACH occasion 210 and also receives an indication that the set of PUSCH occasions 215 is relatively low, the UE 115-a may add the RACH occasion 210 and invalidate an already valid PUSCH occasion 215, if the RACH occasion 210 overlaps with the already valid PUSCH occasion 215.

FIG. 3A shows an example of a resource diagram 300 that supports validating PUSCH resource occasions in accordance with one or more aspects of the present disclosure. Aspects of the resource diagram 300 may be implemented by aspects of the wireless communications system 100 and the wireless communications system 200 as described herein with reference to FIGS. 1 and 2. For example, aspects of the resource diagram 300 may be implemented by a UE 115 as described herein. Techniques described in the context of the resource diagram 300 may enable the UE 115 to determine whether to validate or invalidate a PUSCH occasion 215 in response to an addition of a RACH occasion 210.

For example, the UE 115 may receive, from a network entity 105, first control signaling that allocates resources 305, where the resources 305 may include a RACH occasion 210-c and a set of PUSCH occasions 215 including a PUSCH occasion 215-a, a PUSCH occasion 215-b, a PUSCH occasion 215-c, and a PUSCH occasion 215-d. In some examples, the UE 115-a may receive a dynamic indication, via second control signaling, adding a RACH occasion 210-d to the resources 305, where the RACH occasion 210-d may overlap with an existing valid PUSCH occasion 215, such as the PUSCH occasion 215-d.

In the example of the resources 310, in response to receiving the indication to add the RACH occasion 210-d, the UE 115 may determine to drop the RACH occasion 210-d and maintain the validity of the of the PUSCH occasion 215-d. In such examples, the UE 115 may be a legacy UE and not be aware of the dynamic adaptation.

Alternatively, in the example of the resources 315, in response to receiving the indication to add the RACH occasion 210-d, the UE 115 may determine to invalidate the PUSCH occasion 215-d (e.g., already valid PUSCH occasion 215) and add the RACH occasion 210-d to the assigned resource. In such examples, the UE 115 may refrain from changing the RACH occasion 210 to PUSCH occasion 215 (e.g., preamble to PUSCH occasion or preamble to PRU) mapping. As such, the UE 115 may utilize the RACH occasion 210-d for a four-step RACH procedure. Alternatively, in some examples, the network entity 105 may indicate that the RACH occasion 210-d is associated with a second set of PUSCH occasions 215, such as a PUSCH occasion 215-e, a PUSCH occasion 215-f, a PUSCH occasion 215-g, and a PUSCH occasion 215-h.

In the example of the resources 320, in response to receiving the indication to add the RACH occasion 210-d, the UE 115 may determine to invalidate the PUSCH occasion 215-d (e.g., already valid PUSCH occasion 215) and add the RACH occasion 210-d to the assigned resource. In such examples, the UE 115 may change (e.g., adapt) the RACH occasion 210 to PUSCH occasion 215 (e.g., preamble to PUSCH occasion or preamble to PRU) mapping by adding one or more additional PUSCH occasions 215 to the set of PUSCH occasions 215 based on adding RACH occasion 210-d. For example, the UE 115 may add a PUSCH occasion 215-i, a PUSCH occasion 215-j, a PUSCH occasion 215-k, and a PUSCH occasion 215-1 to the set of PUSCH occasions and procced to update one or more PRU indices, preamble indices, or both of each PUSCH occasion 215 of the updated set of PUSCH occasions.

FIG. 3B shows an example of a resource diagram 301 that supports validating PUSCH resource occasions in accordance with one or more aspects of the present disclosure. Aspects of the resource diagram 301 may be implemented by aspects of the wireless communications system 100 and the wireless communications system 200 as described herein with reference to FIGS. 1 and 2. For example, aspects of the resource diagram 301 may be implemented by a UE 115 as described herein. Techniques described in the context of the resource diagram 301 may enable the UE 115 to determine whether to validate or invalidate a PUSCH occasion 215 in response to removal of a RACH occasion 210.

For example, the UE 115 may receive, from a network entity 105, first control signaling that allocates resources 325, where the resources 325 may include a RACH occasion 210-e, a RACH occasion 210-d, and a set of PUSCH occasions 215, where the RACH occasion 210-e may be associated with a PUSCH occasion 215-m, a PUSCH occasion 215-n, and a PUSCH occasion 215-0, and where the RACH occasion 210-f may be associated with a PUSCH occasion 215-q, a PUSCH occasion 215-r, a PUSCH occasion 215-s, a PUSCH occasion 215-t, and a PUSCH occasion 215-p. In such examples, the PUSCH occasion 215-p may be invalidated due to the RACH occasion 210-f overlapping, in time and frequency, with the PUSCH occasion 215-p. In some examples, the UE 115-a may receive a dynamic indication, via second control signaling, removing the RACH occasion 210-f (e.g., a RACH slot) from the resources 305, where the RACH occasion 210-f may overlap with a previously invalidated PUSCH occasion 215, such as the PUSCH occasion 215-p.

In the example of the resources 330, the UE 115 may remove the RACH occasion 210-f and maintain the invalidity of the PUSCH occasion 215-p. In response to removing the RACH occasion 210-f, the UE 115 may also adapt the mapping between the RACH occasion 210-f and the PUSCH occasions 215-q, 215-r, 215-s, and 215-t. For example, the UE 115 may remove such PUSCH occasions 215 from the resources 330.

In the example of the resources 335, the UE 115 may remove the RACH occasion 210-f and validate the PUSCH occasion 215-p. In response to removing the RACH occasion 210-f, the UE 115 may refrain from changing the mapping between the RACH occasion 210-f and the PUSCH occasions 215-q, 215-r, 215-s, and 215-t. For example, the UE 115 may maintain such PUSCH occasions 215 in the resources 340. In such examples, the UE 115 may adjust the PRU IDs, preamble indices, or both of the PUSCH occasions 215 to account for the removal of the RACH occasion 210-f.

In the example of the resources 340, the UE 115 may remove the RACH occasion 210-f and validate the PUSCH occasion 215-p. In response to removing the RACH occasion 210-f, the UE 115 may also adapt the mapping between the RACH occasion 210-f and the PUSCH occasions 215-q, 215-r, 215-s, and 215-t. For example, the UE 115 may remove such PUSCH occasions 215 from the resources 340.

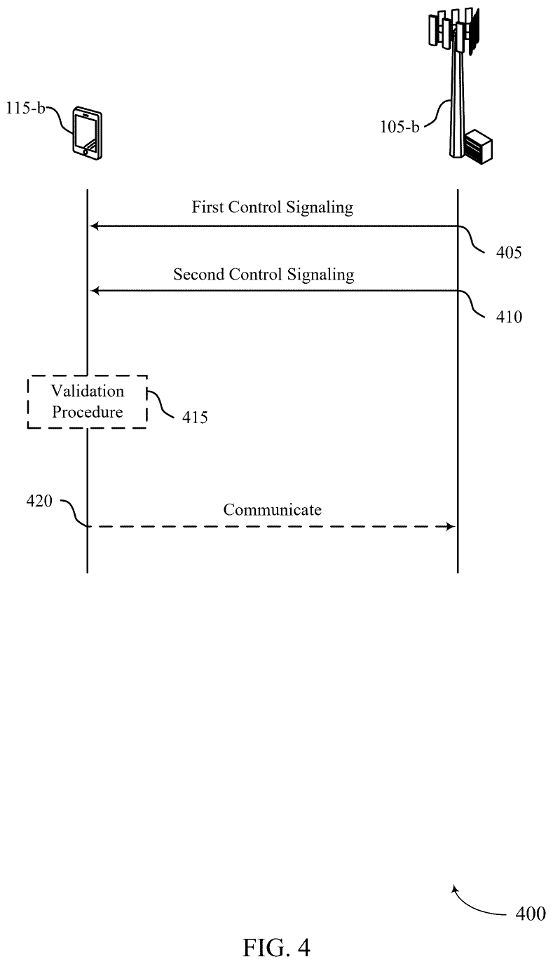

FIG. 4 shows an example of a process flow 400 that supports validating PUSCH resource occasions in accordance with one or more aspects of the present disclosure. Aspects of the process flow 400 may implement, or be implemented by, aspects of the wireless communications system 100, the wireless communications system 200, the resource diagram 300, the resource diagram 301, or a combination thereof as described herein with reference to FIGS. 1-3B. For example, the operations of the process flow 400 may be implemented by a UE 115-b and a network entity 105-b, which may be examples of UEs 115 and network entities 105, respectively, as described herein.

At 405, the network entity 105-b may transmit first control signaling, such as the first control signaling 230, that indicates a set of RACH occasions, a set of PUSCH occasions, a set of SSB resources, or a combination thereof. In such examples, the first control signaling may be an example of a SIB, as described herein with reference to FIG. 2.

At 410, the network entity 105-b may transmit second control signaling, such as the second control signaling 235, indicating an update to the set of RACH occasions, the set of SSB resources, or both. In such examples, the second control signaling may be an example of a paging message, as described herein with reference to FIG. 2. For example, the network entity 105-b may indicate a removal of one or more RACH occasions, a removal of one or more SSB resources, an addition of one or more RACH occasions, an addition of one or more SSB resources, or a combination thereof. In some examples, the network entity 105-b may also indicate, via the second control signaling, a priority associated with the set of PUSCH occasions 215, such that the UE 115-b may utilize the indicated priority during the validation procedures, as described herein with reference to FIG. 2.

At 415, the UE 115-b may perform a validation procedure to determine whether to validate or invalidate one or more PUSCH occasions of the set in response to the updates to the RACH occasions, the updates to the SSB occasions, or both. For example, the UE 115-b may determine whether to validate or invalidate a PUSCH occasion in response to the addition of a RACH occasion according to the techniques described herein with reference to FIGS. 2 and 3A. Similarly, the UE 115-b may determine whether to validate or invalidate the PUSCH occasion in response to removal of a RACH occasion according to the techniques described herein with reference to FIGS. 2 and 3B. Additionally, the UE 115-b may determine whether to invalidate or validate the PUSCH occasion in response to the addition or removal of an SSB according to the techniques described herein with reference to FIG. 2.

At 420, in response to performing the validation procedure at 415, the UE 115-b may communicate with the network entity 105-b via the set of PUSCH occasions. For example, the UE 115-b may perform a two-step RACH procedure using the set of PUSCH occasions, as described herein with reference to FIG. 2.

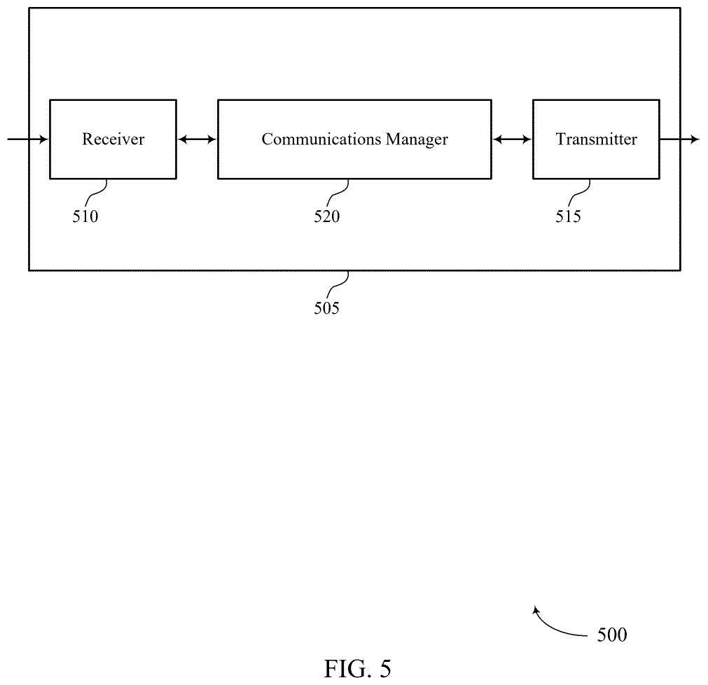

FIG. 5 shows a block diagram 500 of a device 505 that supports validating PUSCH resource occasions in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to validating PUSCH resource occasions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to validating PUSCH resource occasions). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of validating PUSCH resource occasions as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving first control signaling that indicates a set of PUSCH occasions, a set of RACH occasions, a set of SSB resources, or a combination thereof. The communications manager 520 is capable of, configured to, or operable to support a means for receiving second control signaling that indicates an update to the set of RACH occasions, an update to the set of SSB resources, or both. The communications manager 520 is capable of, configured to, or operable to support a means for performing a validation procedure to determine whether to invalidate or validate at least a first PUSCH occasion of the set of PUSCH occasions based on the update to the set of RACH occasions, the update to the set of SSB resources, or both. The communications manager 520 is capable of, configured to, or operable to support a means for communicating via the set of PUSCH occasions according to the validation procedure.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for validating PUSCH occasions based on adaptations to SSB resources, RACH occasions or both, which may reduce processing and provide for a more efficient utilization of communication resources.

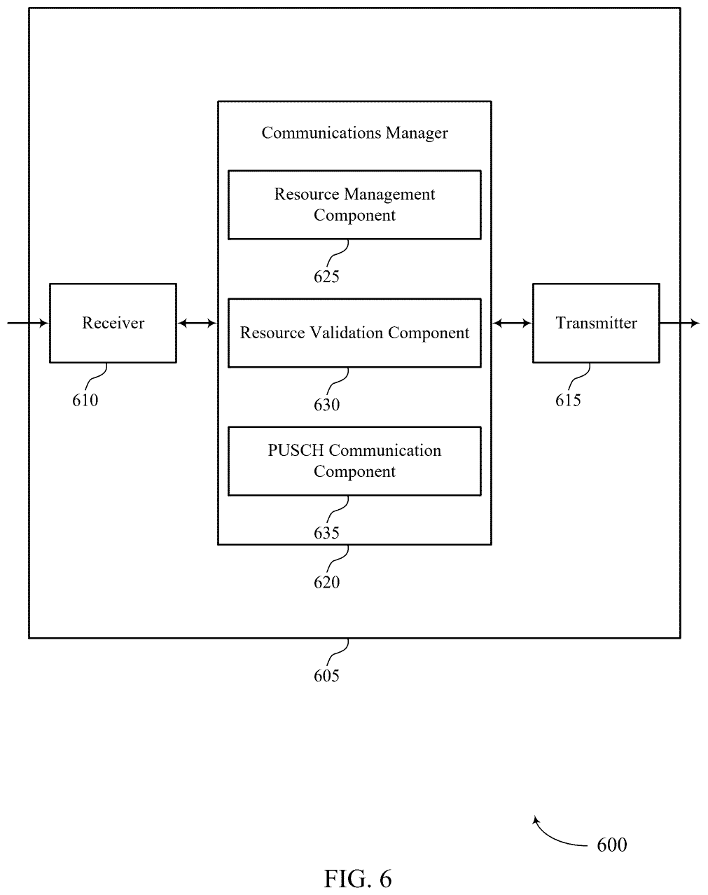

FIG. 6 shows a block diagram 600 of a device 605 that supports validating PUSCH resource occasions in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to validating PUSCH resource occasions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to validating PUSCH resource occasions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of validating PUSCH resource occasions as described herein. For example, the communications manager 620 may include a resource management component 625, a resource validation component 630, an PUSCH communication component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The resource management component 625 is capable of, configured to, or operable to support a means for receiving first control signaling that indicates a set of PUSCH occasions, a set of RACH occasions, a set of SSB resources, or a combination thereof. The resource management component 625 is capable of, configured to, or operable to support a means for receiving second control signaling that indicates an update to the set of RACH occasions, an update to the set of SSB resources, or both. The resource validation component 630 is capable of, configured to, or operable to support a means for performing a validation procedure to determine whether to invalidate or validate at least a first PUSCH occasion of the set of PUSCH occasions based on the update to the set of RACH occasions, the update to the set of SSB resources, or both. The PUSCH communication component 635 is capable of, configured to, or operable to support a means for communicating via the set of PUSCH occasions according to the validation procedure.

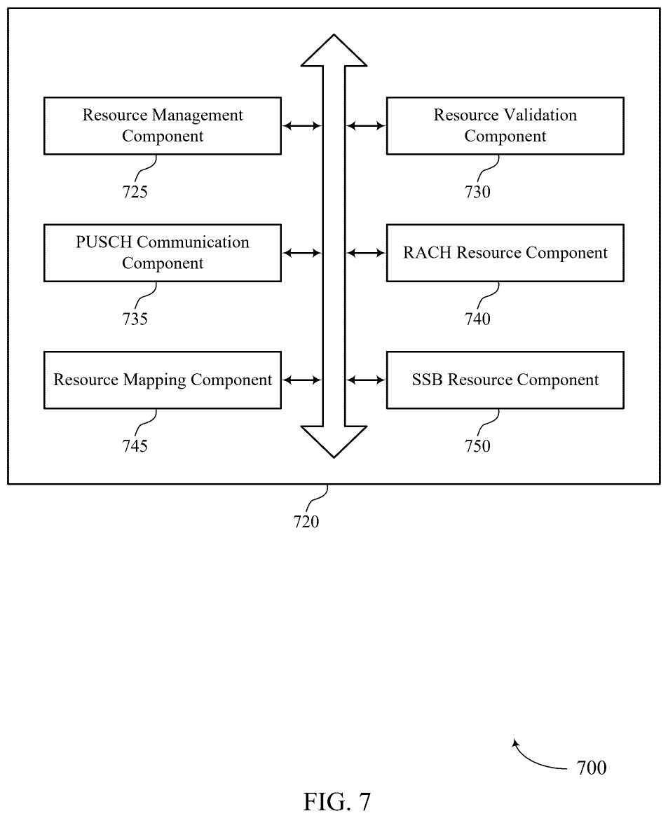

FIG. 7 shows a block diagram 700 of a communications manager 720 that supports validating PUSCH resource occasions in accordance with one or more aspects of the present disclosure. The communications manager 720 may be an example of aspects of a communications manager 520, a communications manager 620, or both, as described herein. The communications manager 720, or various components thereof, may be an example of means for performing various aspects of validating PUSCH resource occasions as described herein. For example, the communications manager 720 may include a resource management component 725, a resource validation component 730, an PUSCH communication component 735, a RACH resource component 740, a resource component 745, an SSB resource component 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The resource management component 725 is capable of, configured to, or operable to support a means for receiving first control signaling that indicates a set of PUSCH occasions, a set of RACH occasions, a set of SSB resources, or a combination thereof. In some examples, the resource management component 725 is capable of, configured to, or operable to support a means for receiving second control signaling that indicates an update to the set of RACH occasions, an update to the set of SSB resources, or both. The resource validation component 730 is capable of, configured to, or operable to support a means for performing a validation procedure to determine whether to invalidate or validate at least a first PUSCH occasion of the set of PUSCH occasions based on the update to the set of RACH occasions, the update to the set of SSB resources, or both. The PUSCH communication component 735 is capable of, configured to, or operable to support a means for communicating via the set of PUSCH occasions according to the validation procedure.

In some examples, to support performing the validation procedure, the RACH resource component 740 is capable of, configured to, or operable to support a means for dropping the first RACH occasion from the set of RACH occasions. In some examples, to support performing the validation procedure, the resource validation component 730 is capable of, configured to, or operable to support a means for validating the first PUSCH occasion based on dropping the first RACH occasion.

In some examples, to support performing the validation procedure, the resource validation component 730 is capable of, configured to, or operable to support a means for invalidating the first PUSCH occasion based on adding the first RACH occasion.

In some examples, the resource component 745 is capable of, configured to, or operable to support a means for maintaining a mapping between the set of PUSCH occasions and the set of RACH occasions based on adding the first RACH occasion and invalidating the first PUSCH occasion.

In some examples, the resource component 745 is capable of, configured to, or operable to support a means for adapting a mapping between a second set of PUSCH occasions and the set of RACH occasions based on adding the first RACH occasion and invalidating the first PUSCH occasion.

In some examples, to support performing the validation procedure, the resource validation component 730 is capable of, configured to, or operable to support a means for invalidating the first PUSCH occasion based on removing the first RACH occasion from the set of RACH occasions.

In some examples, the update to the set of RACH occasions includes removing, and the resource validation component 730 is capable of, configured to, or operable to support a means for validating the first PUSCH occasion based on removing the first RACH occasion from the set of RACH occasions.

In some examples, the resource component 745 is capable of, configured to, or operable to support a means for maintaining a mapping between the set of PUSCH occasions and the set of RACH occasions based on invalidating the first PUSCH occasion.

In some examples, the resource component 745 is capable of, configured to, or operable to support a means for adapting a mapping between the set of PUSCH occasions and the set of RACH occasions based on removing the first RACH occasion and validating the first PUSCH occasion, where adapting the mapping includes removal of one or more PUSCH occasions from the set of PUSCH occasions.

In some examples, the update to the set of SSB resources includes adding a first SSB resource. In some examples, the first SSB resource overlaps in time with the first PUSCH occasion; the first PUSCH occasion is within a threshold quantity of symbols from the first SSB resource; or the first SSB resource succeeds, in time, the first PUSCH occasion.

In some examples, to support performing the validation procedure, the resource validation component 730 is capable of, configured to, or operable to support a means for invalidating the first PUSCH occasion based on adding the first SSB resource.

In some examples, the resource component 745 is capable of, configured to, or operable to support a means for maintaining a mapping between the set of PUSCH occasions and the set of RACH occasions based on invalidating the first PUSCH occasion.

In some examples, the resource component 745 is capable of, configured to, or operable to support a means for adapting a mapping between the set of PUSCH occasions and the set of RACH occasions based on adding the first SSB resource and invalidating the first PUSCH occasion.

In some examples, to support performing the validation procedure, the SSB resource component 750 is capable of, configured to, or operable to support a means for excluding the first SSB resource from the set of SSB resources. In some examples, to support performing the validation procedure, the resource validation component 730 is capable of, configured to, or operable to support a means for validating the first PUSCH occasion based on excluding the first SSB resource.

In some examples, the update to the set of SSB resources includes removing a first SSB resource from the set of SSB resources. In some examples, the first SSB resource overlaps in time with the first PUSCH occasion; the first PUSCH occasion is within a threshold quantity of symbols from the first SSB resource; or the first SSB resource succeeds, in time, the first PUSCH occasion.

In some examples, to support performing the validation procedure, the resource validation component 730 is capable of, configured to, or operable to support a means for invalidating the PUSCH occasion based on removing the first SSB resource from the set of SSB resources.

In some examples, to support performing the validation procedure, the resource validation component 730 is capable of, configured to, or operable to support a means for validating the first PUSCH occasion based on removing the first SSB resource from the set of SSB resources.

In some examples, the resource component 745 is capable of, configured to, or operable to support a means for maintaining a mapping between the set of PUSCH occasions and the set of RACH occasions based on removing the first SSB resource and validating the first PUSCH occasion.

In some examples, the resource component 745 is capable of, configured to, or operable to support a means for adapting a mapping between the set of PUSCH occasions and the set of RACH occasions based on removing the first SSB resource and validating the first PUSCH occasion.

In some examples, the second control signaling indicates a priority of the first PUSCH occasion and, to support performing the validation procedure, the resource validation component 730 is capable of, configured to, or operable to support a means for validating the first PUSCH occasion based on the priority of the first PUSCH occasion being greater than or equal to a priority associated with the update to the set of RACH occasions, being greater than or equal to a priority of the update to the set of SSB resources, or both. In some examples, the second control signaling indicates a priority of the first PUSCH occasion and, to support performing the validation procedure, the resource validation component 730 is capable of, configured to, or operable to support a means for invalidating the first PUSCH occasion based on the priority of the first PUSCH occasion being less than the priority associated with the update to the set of RACH occasions, being less than the priority of the update to the set of SSB resources, or both.

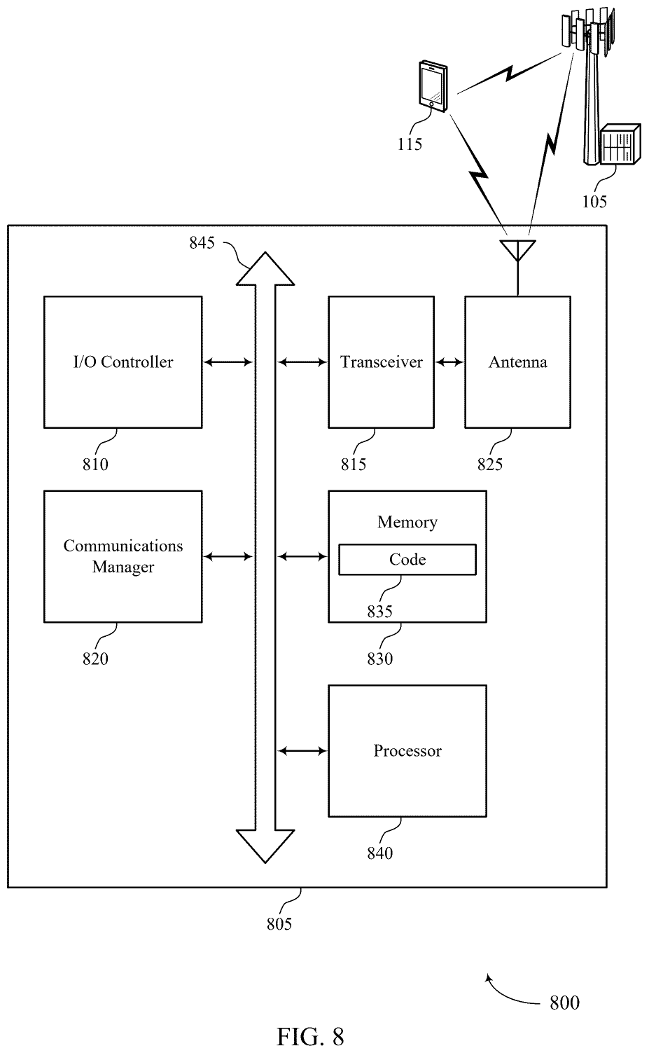

FIG. 8 shows a diagram of a system 800 including a device 805 that supports validating PUSCH resource occasions in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting validating PUSCH resource occasions). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving first control signaling that indicates a set of PUSCH occasions, a set of RACH occasions, a set of SSB resources, or a combination thereof. The communications manager 820 is capable of, configured to, or operable to support a means for receiving second control signaling that indicates an update to the set of RACH occasions, an update to the set of SSB resources, or both. The communications manager 820 is capable of, configured to, or operable to support a means for performing a validation procedure to determine whether to invalidate or validate at least a first PUSCH occasion of the set of PUSCH occasions based on the update to the set of RACH occasions, the update to the set of SSB resources, or both. The communications manager 820 is capable of, configured to, or operable to support a means for communicating via the set of PUSCH occasions according to the validation procedure.

By including or configuring the communications manager 820 in accordance with examples as described herein, the device 805 may support techniques for validating PUSCH occasions based on adaptations to SSB resources, RACH occasions or both, which may reduce processing and provide for a more efficient utilization of communication resources.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of validating PUSCH resource occasions as described herein, or the at least one processor 840 and the at least one memory 830 may be otherwise configured to, individually or collectively, perform or support such operations.

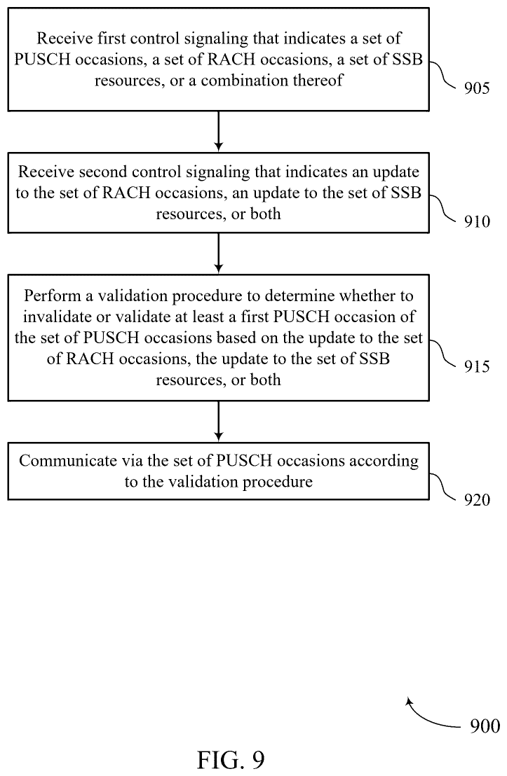

FIG. 9 shows a flowchart illustrating a method 900 that supports validating PUSCH resource occasions in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving first control signaling that indicates a set of PUSCH occasions, a set of RACH occasions, a set of SSB resources, or a combination thereof. The operations of 905 may be performed in accordance with examples as disclosed herein. In some examples, aspects of the operations of 905 may be performed by a resource management component 725 as described with reference to FIG. 7.

At 910, the method may include receiving second control signaling that indicates an update to the set of RACH occasions, an update to the set of SSB resources, or both. The operations of 910 may be performed in accordance with examples as disclosed herein. In some examples, aspects of the operations of 910 may be performed by a resource management component 725 as described with reference to FIG. 7.

At 915, the method may include performing a validation procedure to determine whether to invalidate or validate at least a first PUSCH occasion of the set of PUSCH occasions based on the update to the set of RACH occasions, the update to the set of SSB resources, or both. The operations of 915 may be performed in accordance with examples as disclosed herein. In some examples, aspects of the operations of 915 may be performed by a resource validation component 730 as described with reference to FIG. 7.

At 920, the method may include communicating via the set of PUSCH occasions according to the validation procedure. The operations of 920 may be performed in accordance with examples as disclosed herein. In some examples, aspects of the operations of 920 may be performed by an PUSCH communication component 735 as described with reference to FIG. 7.

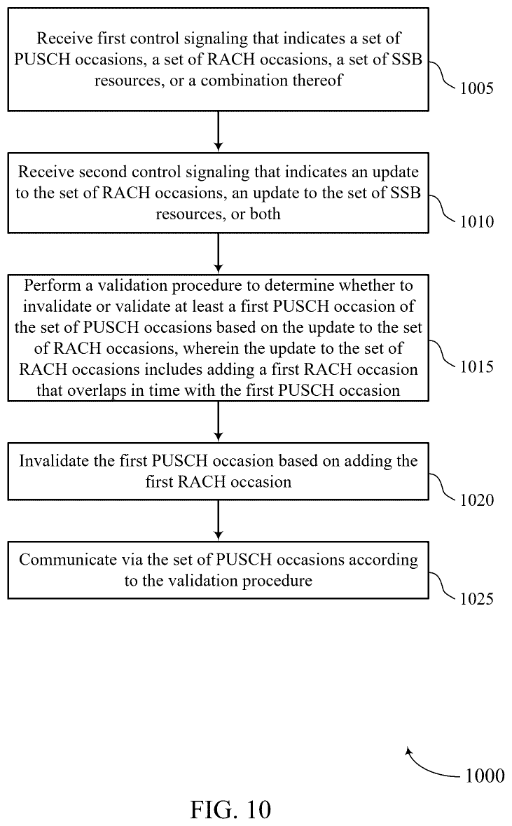

FIG. 10 shows a flowchart illustrating a method 1000 that supports validating PUSCH resource occasions in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving first control signaling that indicates a set of PUSCH occasions, a set of RACH occasions, a set of SSB resources, or a combination thereof. The operations of 1005 may be performed in accordance with examples as disclosed herein. In some examples, aspects of the operations of 1005 may be performed by a resource management component 725 as described with reference to FIG. 7.

At 1010, the method may include receiving second control signaling that indicates an update to the set of RACH occasions, an update to the set of SSB resources, or both. The operations of 1010 may be performed in accordance with examples as disclosed herein. In some examples, aspects of the operations of 1010 may be performed by a resource management component 725 as described with reference to FIG. 7.

At 1015, the method may include performing a validation procedure to determine whether to invalidate or validate at least a first PUSCH occasion of the set of PUSCH occasions based on the update to the set of RACH occasions, wherein the update to the set of RACH occasions includes adding a first RACH occasion that overlaps in time with the first PUSCH occasion. The operations of 1015 may be performed in accordance with examples as disclosed herein. In some examples, aspects of the operations of 1015 may be performed by a resource validation component 730 as described with reference to FIG. 7.

At 1020, the method may include invalidating the first PUSCH occasion based on adding the first RACH occasion. The operations of 1020 may be performed in accordance with examples as disclosed herein. In some examples, aspects of the operations of 1020 may be performed by a resource validation component 730 as described with reference to FIG. 7.

At 1025, the method may include communicating via the set of PUSCH occasions according to the validation procedure. The operations of 1025 may be performed in accordance with examples as disclosed herein. In some examples, aspects of the operations of 1025 may be performed by an PUSCH communication component 735 as described with reference to FIG. 7.

The following provides an overview of aspects of the present disclosure:

Aspect 1: A method for wireless communications at a UE, comprising: receiving first control signaling that indicates a set of PUSCH occasions, a set of RACH occasions, a set of SSB resources, or a combination thereof; receiving second control signaling that indicates an update to the set of RACH occasions, an update to the set of SSB resources, or both; performing a validation procedure to determine whether to invalidate or validate at least a first PUSCH occasion of the set of PUSCH occasions based at least in part on the update to the set of RACH occasions, the update to the set of SSB resources, or both; and communicating via the set of PUSCH occasions according to the validation procedure.

Aspect 2: The method of aspect 1, wherein the update to the set of RACH occasions comprises adding a first RACH occasion that overlaps in time with the first PUSCH occasion, and wherein performing the validation procedure comprises: dropping the first RACH occasion from the set of RACH occasions; and validating the first PUSCH occasion based at least in part on dropping the first RACH occasion.

Aspect 3: The method of any of aspect 1, wherein the update to the set of RACH occasions comprises adding a first RACH occasion that overlaps in time with the first PUSCH occasion, and wherein performing the validation procedure comprises: invalidating the first PUSCH occasion based at least in part on adding the first RACH occasion.

Aspect 4: The method of aspect 3, further comprising: maintaining a mapping between the set of PUSCH occasions and the set of RACH occasions based at least in part on adding the first RACH occasion and invalidating the first PUSCH occasion.

Aspect 5: The method of any of aspects 3 through 4, further comprising: adapting a mapping between a second set of PUSCH occasions and the set of RACH occasions based at least in part on adding the first RACH occasion and invalidating the first PUSCH occasion.

Aspect 6: The method of any of aspect 1, wherein the update to the set of RACH occasions comprises removing, from the set of RACH occasions, a first RACH occasion that overlaps in time with the first PUSCH occasion, and wherein performing the validation procedure comprises: invalidating the first PUSCH occasion based at least in part on removing the first RACH occasion from the set of RACH occasions.

Aspect 7: The method of any of aspect 1, wherein the update to the set of RACH occasions comprises removing, from the set of RACH occasions, a first RACH occasion that overlaps in time with the first PUSCH occasion, the method further comprising: validating the first PUSCH occasion based at least in part on removing the first RACH occasion from the set of RACH occasions.

Aspect 8: The method of aspect 7, further comprising: maintaining a mapping between the set of PUSCH occasions and the set of RACH occasions based at least in part on invalidating the first PUSCH occasion.

Aspect 9: The method of any of aspects 7 through 8, further comprising: adapting a mapping between the set of PUSCH occasions and the set of RACH occasions based at least in part on removing the first RACH occasion and validating the first PUSCH occasion, wherein adapting the mapping comprises removal of one or more PUSCH occasions from the set of PUSCH occasions.

Aspect 10: The method of any of aspects 1 through 9, wherein the update to the set of SSB resources comprises adding a first SSB resource, and the first SSB resource overlaps in time with the first PUSCH occasion; the first PUSCH occasion is within a threshold quantity of symbols from the first SSB resource; or the first SSB resource succeeds, in time, the first PUSCH occasion.

Aspect 11: The method of aspect 10, wherein performing the validation procedure comprises: invalidating the first PUSCH occasion based at least in part on adding the first SSB resource.

Aspect 12: The method of aspect 11, further comprising: maintaining a mapping between the set of PUSCH occasions and the set of RACH occasions based at least in part on invalidating the first PUSCH occasion.

Aspect 13: The method of any of aspects 11 through 12, further comprising: adapting a mapping between the set of PUSCH occasions and the set of RACH occasions based at least in part on adding the first SSB resource and invalidating the first PUSCH occasion.

Aspect 14: The method of any of aspect 10, wherein performing the validation procedure comprises: excluding the first SSB resource from the set of SSB resources; and validating the first PUSCH occasion based at least in part on excluding the first SSB resource.

Aspect 15: The method of any of aspects 1 through 9, wherein the update to the set of SSB resources comprises removing a first SSB resource from the set of SSB resources, and the first SSB resource overlaps in time with the first PUSCH occasion; the first PUSCH occasion is within a threshold quantity of symbols from the first SSB resource; or the first SSB resource succeeds, in time, the first PUSCH occasion.

Aspect 16: The method of aspect 15, wherein performing the validation procedure comprises: invalidating the PUSCH occasion based at least in part on removing the first SSB resource from the set of SSB resources.

Aspect 17: The method of any of aspect 15, wherein performing the validation procedure comprises: validating the first PUSCH occasion based at least in part on removing the first SSB resource from the set of SSB resources.

Aspect 18: The method of aspect 17, further comprising: maintaining a mapping between the set of PUSCH occasions and the set of RACH occasions based at least in part on removing the first SSB resource and validating the first PUSCH occasion.

Aspect 19: The method of any of aspects 17 through 18, further comprising: adapting a mapping between the set of PUSCH occasions and the set of RACH occasions based at least in part on removing the first SSB resource and validating the first PUSCH occasion.

Aspect 20: The method of any of aspects 1 through 19, wherein the second control signaling indicates a priority of the first PUSCH occasion, and performing the validation procedure comprises: validating the first PUSCH occasion based at least in part on the priority of the first PUSCH occasion being greater than or equal to a priority associated with the update to the set of RACH occasions, being greater than or equal to a priority of the update to the set of SSB resources, or both; or invalidating the first PUSCH occasion based at least in part on the priority of the first PUSCH occasion being less than the priority associated with the update to the set of RACH occasions, being less than the priority of the update to the set of SSB resources, or both.

Aspect 21: A UE for wireless communications, comprising one or more memories storing processor-executable code, and one or more processors coupled with the one or more memories and individually or collectively operable to execute the code to cause the UE to perform a method of any of aspects 1 through 20.

Aspect 22: A UE for wireless communications, comprising at least one means for performing a method of any of aspects 1 through 20.

Aspect 23: A non-transitory computer-readable medium storing code for wireless communications, the code comprising instructions executable by one or more processors to perform a method of any of aspects 1 through 20.

It should be noted that the methods described herein describe possible implementations. The operations and the steps may be rearranged, or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling that indicates a set of physical uplink shared channel (PUSCH) occasions, a set of random access channel (RACH) occasions, a set of synchronization signal block (SSB) resources, or a combination thereof;
receive second control signaling that indicates an update to the set of RACH occasions, an update to the set of SSB resources, or both;
perform a validation procedure to determine whether to invalidate or validate at least a first PUSCH occasion of the set of PUSCH occasions based at least in part on the update to the set of RACH occasions, the update to the set of SSB resources, or both; and
communicate via the set of PUSCH occasions according to the validation procedure.

2. The UE of claim 1, wherein the update to the set of RACH occasions comprises adding a first RACH occasion that overlaps in time with the first PUSCH occasion, and wherein, to perform the validation procedure, the one or more processors are individually or collectively operable to execute the code to cause the UE to:
drop the first RACH occasion from the set of RACH occasions; and
validate the first PUSCH occasion based at least in part on dropping the first RACH occasion.

3. The UE of claim 1, wherein the update to the set of RACH occasions comprises adding a first RACH occasion that overlaps in time with the first PUSCH occasion, and wherein, to perform the validation procedure, the one or more processors are individually or collectively operable to execute the code to cause the UE to:
invalidate the first PUSCH occasion based at least in part on adding the first RACH occasion.

4. The UE of claim 3, wherein the one or more processors are individually or collectively further operable to execute the code to cause the UE to:
maintain a mapping between the set of PUSCH occasions and the set of RACH occasions based at least in part on adding the first RACH occasion and invalidating the first PUSCH occasion.

5. The UE of claim 3, wherein the one or more processors are individually or collectively further operable to execute the code to cause the UE to:
adapt a mapping between a second set of PUSCH occasions and the set of RACH occasions based at least in part on adding the first RACH occasion and invalidating the first PUSCH occasion.

6. The UE of claim 1, wherein the update to the set of RACH occasions comprises removing, from the set of RACH occasions, a first RACH occasion that overlaps in time with the first PUSCH occasion, and wherein, to perform the validation procedure, the one or more processors are individually or collectively operable to execute the code to cause the UE to:
invalidate the first PUSCH occasion based at least in part on removing the first RACH occasion from the set of RACH occasions.

7. The UE of claim 1, wherein the update to the set of RACH occasions comprises removing, from the set of RACH occasions, a first RACH occasion that overlaps in time with the first PUSCH occasion, and wherein, to perform the validation procedure, the one or more processors are individually or collectively operable to execute the code to cause the UE to:
validate the first PUSCH occasion based at least in part on removing the first RACH occasion from the set of RACH occasions.

8. The UE of claim 7, wherein the one or more processors are individually or collectively further operable to execute the code to cause the UE to:
maintain a mapping between the set of PUSCH occasions and the set of RACH occasions based at least in part on invalidating the first PUSCH occasion.

9. The UE of claim 7, wherein the one or more processors are individually or collectively further operable to execute the code to cause the UE to:
adapt a mapping between the set of PUSCH occasions and the set of RACH occasions based at least in part on removing the first RACH occasion and validating the first PUSCH occasion, wherein adapting the mapping comprises removal of one or more PUSCH occasions from the set of PUSCH occasions.

10. The UE of claim 1, wherein the update to the set of SSB resources comprises adding a first SSB resource, and wherein the first SSB resource overlaps in time with the first PUSCH occasion, the first PUSCH occasion is within a threshold quantity of symbols from the first SSB resource, or the first SSB resource succeeds, in time, the first PUSCH occasion.

11. The UE of claim 10, wherein, to perform the validation procedure, the one or more processors are individually or collectively operable to execute the code to cause the UE to:
invalidate the first PUSCH occasion based at least in part on adding the first SSB resource.

12. The UE of claim 11, wherein the one or more processors are individually or collectively further operable to execute the code to cause the UE to:
adapt a mapping between the set of PUSCH occasions and the set of RACH occasions based at least in part on adding the first SSB resource and invalidating the first PUSCH occasion.

13. The UE of claim 10, wherein, to perform the validation procedure, the one or more processors are individually or collectively operable to execute the code to cause the UE to:
exclude the first SSB resource from the set of SSB resources; and
validate the first PUSCH occasion based at least in part on excluding the first SSB resource.

14. The UE of claim 1, wherein the update to the set of SSB resources comprises removing a first SSB resource from the set of SSB resources, and wherein the first SSB resource overlaps in time with the first PUSCH occasion, the first PUSCH occasion is within a threshold quantity of symbols from the first SSB resource, or the first SSB resource succeeds, in time, the first PUSCH occasion.

15. The UE of claim 14, wherein, to perform the validation procedure, the one or more processors are individually or collectively operable to execute the code to cause the UE to:
invalidate the PUSCH occasion based at least in part on removing the first SSB resource from the set of SSB resources.

16. The UE of claim 14, wherein, to perform the validation procedure, the one or more processors are individually or collectively operable to execute the code to cause the UE to:
validate the first PUSCH occasion based at least in part on removing the first SSB resource from the set of SSB resources.

17. The UE of claim 16, wherein the one or more processors are individually or collectively further operable to execute the code to cause the UE to:
maintain a mapping between the set of PUSCH occasions and the set of RACH occasions based at least in part on removing the first SSB resource and validating the first PUSCH occasion.

18. The UE of claim 1, wherein the second control signaling indicates a priority of the first PUSCH occasion, and, to perform the validation procedure, the one or more processors are individually or collectively operable to execute the code to cause the UE to:
validate the first PUSCH occasion based at least in part on the priority of the first PUSCH occasion being greater than or equal to a priority associated with the update to the set of RACH occasions, being greater than or equal to a priority of the update to the set of SSB resources, or both; or
invalidate the first PUSCH occasion based at least in part on the priority of the first PUSCH occasion being less than the priority associated with the update to the set of RACH occasions, being less than the priority of the update to the set of SSB resources, or both.

19. A method for wireless communications at a user equipment (UE), comprising:
receiving first control signaling that indicates a set of physical uplink shared channel (PUSCH) occasions, a set of random access channel (RACH) occasions, a set of synchronization signal block (SSB) resources, or a combination thereof;
receiving second control signaling that indicates an update to the set of RACH occasions, an update to the set of SSB resources, or both;
performing a validation procedure to determine whether to invalidate or validate at least a first PUSCH occasion of the set of PUSCH occasions based at least in part on the update to the set of RACH occasions, the update to the set of SSB resources, or both; and
communicating via the set of PUSCH occasions according to the validation procedure.

20. A non-transitory computer-readable medium storing code for wireless communications, the code comprising instructions executable by one or more processors to:
receive first control signaling that indicates a set of physical uplink shared channel (PUSCH) occasions, a set of random access channel (RACH) occasions, a set of synchronization signal block (SSB) resources, or a combination thereof;
receive second control signaling that indicates an update to the set of RACH occasions, an update to the set of SSB resources, or both;
perform a validation procedure to determine whether to invalidate or validate at least a first PUSCH occasion of the set of PUSCH occasions based at least in part on the update to the set of RACH occasions, the update to the set of SSB resources, or both; and
communicate via the set of PUSCH occasions according to the validation procedure.
